(19) United States
(12) Patent Application Publication
(10) Pub. No.: US 2026/0240075 A1
(43) Pub. Date: Aug. 20, 2026

(54) MATERIAL FLOW MONITORING

(71) Applicant: AGCO International GmbH, Neuhausen Am Rheinfall (CH)

(72) Inventors: Morten Stigaard LAURSEN, Randers (DK); Martin Peter CHRISTIANSEN, Randers (DK)

(21) Appl. No.: 19/471,261

(22) PCT Filed: Feb. 27, 2024
(86) PCT No.: PCT/IB2024/051847

§ 371 Date: Sep. 30, 2025

(30) Foreign Application Priority Data
Mar. 30, 2023 (GB) 2304749.1

(51) Int. Cl. A01D 41/127; G01P 5/00

(52) U.S. Cl. CPC A01D 41/127; G01P 5/001

(57) ABSTRACT

Methods and systems are provided monitoring operation of an implement for an agricultural machine. Sensor data from an event based sensor which is mounted or otherwise associated with the agricultural machine is used to identify a flow of material associated with the implement. One or more flow parameters for the material flow are determined for the material flow and operation of one or more operable components associated with the agricultural machine are then controlled in dependence on the determined flow parameter(s).

### CROSS-REFERENCE TO RELATED APPLICATIONS

Not applicable.

### FIELD

Embodiments of the present disclosure relate generally to systems and methods for monitoring operation of an agricultural implement, and specifically to monitoring material flow associated with the implement.

### BACKGROUND

Many agricultural processes involve the use of an implement operably coupled to a machine for engaging or otherwise processing material, such as crop material. Such processes typically require an operator to monitor the effectiveness of the operation and adjust components of the machine and/or implement accordingly.

For example, in a conventional harvesting process using a harvesting machine such as a combine harvester, an operator is required to manually adjust numerous parameters of the harvester in order to maintain an acceptable/desirable flow of material through the header and into the machine to ensure that all available crop material is harvested as efficiently and quickly as possible whilst at the same time preventing any blockages from occurring, e.g. through overworking of various components of the header and/or machine due to an excessively high flow rate of material through the components. This typically involves the operator adjusting the parameters to achieve a substantially uniform flow of material into and through the header, e.g. laterally across the header. Such parameters may include the height of the header, reel speed, reel height, reel position, belt speeds, cutter bar speeds and position, pitch angle of the header, etc. This can result in a high operator workload, leading to an increased likelihood of operator error and ultimately reduced efficiency and effectiveness of the harvesting process as a whole.

Whilst some of these parameters may be automated—e.g. adjusting header height automatically based on crop height—the operator is still required to monitor and control multiple parameters simultaneously based on a physical observation of the material flow through the header during operation.

It would therefore be advantageous to provide an improved system and method for monitoring material flow through an agricultural implement, such as a harvesting header, which further assists an operator and/or provide means for fully automating such processes.

### BRIEF SUMMARY

In an aspect of the invention there is provided a system for monitoring operation of an implement for an agricultural machine, the system comprising: an event based sensor; and a control system comprising one or more controllers, collectively configured to: receive sensor data from the event based sensor indicative of an operating region of the implement; analyse the sensor data to identify a flow of material associated with the implement; determine one or more flow parameters for the material flow; and generate and output one or more control signals for controlling operation of one or more operable components associated with the agricultural machine in dependence on the determined flow parameter(s).

Advantageously, the present solution may provide means to monitor flow parameters associated with material flow with respect to an agricultural implement, such as a header for a harvesting machine. As discussed herein, an event based sensor may advantageously provide a greater understanding of the material motion when compared with conventional, optical based imaging systems, and may be used in low light conditions for example, where RGB or other camera based systems may be unusable.

When used herein and throughout the term “event based sensor” is intended to include a sensor having multiple individual sensing elements or pixels which are individually triggerable in dependence on one or more variations in the signal output associated with those elements. The one or more variations result from a change in the light incident on said sensing elements, resulting in a change in amplitude in the output signal of those sensing elements. By setting relevant thresholds for said variations, “events” can be triggered in dependence on a given change in incident light on said sensing elements. Such a change may indicate movement in the observed environment, for example. Such sensor types may also be referred to as a neuromorphic camera, a silicon retina or dynamic vision sensor.

The one or more flow parameters may be used to determine a performance metric for the implement and its operation. For instance, the one or more flow parameters may be used to identify an operational issue associated with the implement, e.g. plugging of material, component breakage etc. This may be identified via a change in the flow parameter at the location of the blockage and/or at the location of faulty componentry of the implement, and/or a difference in flow parameter(s) across the implement and/or with respect to a baseline measurement—i.e. an expected flow parameter under given operating conditions.

Determination of the flow parameter(s) may comprise determining a performance metric in the form of a measure of a uniformity of flow across the implement. The one or more controllers, for example, may be configured to compare flow parameter(s) for each of two or more sub-regions of the implement and determine a uniformity of flow associated with the implement in dependence on the comparison. Where material is determined to be flowing at different rates across the implement this may be indicative of a material blockage or faulty equipment.

Determination of the flow parameter(s) may comprise determining a performance metric in the form of a measure of a uniformity of flow from the implement. The one or more controllers, for example, may be configured to compare flow parameter(s) for each of two or more sub-regions of the implement and determine a uniformity of flow from the implement in dependence on the comparison. Where material is determined to be flowing at different rates from different sub-regions of the implement this may be indicative of a material blockage or faulty equipment.

The one or more controllers may be configured to control application of a filter to output signals from the sensing elements. The filter may be applied to the output signals to remove triggers of individual sensing elements due to background motion. For example, this may be due to the relative movement of the ground causing changes in the light incident on the sensing elements as the machine performs a task, or due to structural vibration and/or component motion during said tasks. Advantageously, applying one or more filters to the analogue output signal from the sensing elements may control the number of individual triggers to be processed by the event based sensor and/or one or more processing units associated therewith.

Additionally or alternatively, the one or more controllers may be configured to apply a filter to the sensor data. Where the processing capabilities of the controllers is high enough it may be possible to receive all triggers and apply said filter(s) digitally to remove or discard unwanted triggers.

The filter may comprise a threshold for an output signal associated with the sensing elements, which may include amplitude or rate of change of amplitude of the output signal. The threshold may be definable and/or be dependent on the agricultural task (to be) performed by the agricultural machine.

The filter may be dependent on a ground speed of the agricultural machine. Advantageously, the relative movement of the ground with respect to the machine, and hence the sensor, may be excluded from the sensor data. The filter may be dependent on an operational speed of the implement, which may include a rotational speed or one or more rotational components of the implement, for example.

The filter may comprise a mask applied to a sensing region of the sensor, e.g. to exclude regions of the sensing region which do not correspond to the implement and/or a material flow associated therewith.

The one or more controllers may be configured to determine the flow parameter(s) through performance of an optical flow measurement on the received sensor data. The optical flow measurement may provide a flow parameter comprising a measure of a direction, speed or velocity distribution associated with material movement within the sensing region of the sensor. The optical flow measurement may provide a measure of a uniformity of the material flow associated with the implement. The one or more controllers may be operable to identify one or more anomalies in the optical flow measurement. The one or more anomalies may correspond to regions of the material flow exhibiting unusual flow parameters—e.g. a different speed or different flow direction when compared with other areas or regions of the material flow, or when compared with an expected flow parameter(s).

The system may include one or more additional sensors. Data from the one or more additional sensors may be useable by the one or more controllers for positioning of the implement within the sensor data from the event based sensor, for example. The one or more additional sensors may comprise a camera, LIDAR unit, RADAR unit or the like.

The implement may comprise an integral part of the agricultural machine. The implement may be a separable mountable component which may be operably coupled to the machine, as will be appreciated.

The implement may comprise a header for a harvesting machine, such as a header for a combine harvester. The header may include one or more operable components, such as a reel, conveyor, cutter bar or the like, as will be appreciated.

The implement may comprise a boom or the like, including one or more outlets for dispensing/spreading material therefrom. This may include, for instance, sprayers including the dispensing of fluid (e.g. water, herbicides, pesticides etc.) therefrom. The system may be operable to monitor the flow of the fluid material from one or more outlets or nozzles of the boom, for example. The system may be operable to monitor one or more properties of the distribution of material from the one or more outlets. This may include a shape of the distribution, for example. This may include a measure of a spray pattern for one or more of the outlets. This may be indicative of a spray drift, e.g. due to environmental conditions whilst spraying and/or component configuration. The system may be operable to monitor the uniformity of material flow from two or more outlets.

In embodiments, the implement may comprise a spreader tool. For example, the spreader tool may include a fertiliser spreader operably mounted to the machine for dispensing of fertiliser material therefrom. The system may utilise the event based sensor to monitor the flow of fertiliser material from one or more outlets of the spreader tool. The spreader tool may comprise a spreader tool for a harvesting machine, for spreading residue material therefrom.

The one or more controllers may be configured to determine one or more flow parameters in the form of a characteristic of the distribution of material flow from the spreader tool. The characteristic(s) may comprise a measure of the width of the distribution. The characteristic(s) can comprise a measure of the uniformity of the material distribution across its width. This may comprise a comparison of the intensity of a histogram/heatmap of events across the distribution indicative of how evenly the material is spread in the distribution. This may comprise a measure of a distance material is ejected in a given direction compared with an opposite direction-e.g. first and second directions/left-right of the machine. The one or more characteristics of the material distribution may include a shape of the distribution. The one or more characteristics of the material distribution may include a skew of the distribution. The skew may comprise a relative measure of an amount of material in one or more sub-regions of the sensing region of the sensor. This may include a relative measure of an amount of material left or right of a centerline located substantially centrally along a longitudinal axis of the machine. The one or more characteristics of the material distribution may include a distance at which the material is spread. This may include a distance from the spreader tool at which the material is spread. The one or more characteristics of the material distribution may include a maximum lateral extent of material spread by the spreader tool. The one or more characteristics of the material distribution may include a density of material across the material distribution. Such characteristic may be indicative of an issue with component calibration, such as a directionality of the spreader tool, for example, and/or environmental conditions including drift due to the wind direction, for example.

The implement may comprise a grass turning implement. The one or more controllers may be configured to monitor a distribution of material dispersed by the grass turning implement. For example, the one or more controllers may utilise the sensor data to determine a dispersion distance and/or direction of the material.

The one or more operable components of or otherwise associated with the machine may include a user interface. The user interface may comprise a display screen, which may be provided as part of a user terminal of the machine, e.g. in an operator cab of the machine. Additionally or alternatively, the user interface may be provided by a portable user device, e.g. one carried by a user/operator during operation of the machine. The portable user device may comprise a smartphone, tablet computer, laptop or the like.

The one or more controllers may be configured to control output of an indicator indicative of the determined flow parameter(s). Specifically, the one or more controllers may be configured to generate and output a control signal(s) to the user interface for causing output of the indicator via the user interface to an operator of the machine.

The indicator may comprise a warning indicative of an identified anomaly in the material flow associated with the implement, for example. The warning may be an audible and/or a visual warning.

The indicator may comprise a representation of the implement and/or the material flow associated therewith. For example, the one or more controllers may be configured to control output of a graphical representation of the implement and/or material flow via the user interface. This may comprise senor data (e.g. an image feed from the one or more additional sensors) and/or a generated virtual representation of the implement and/or material flow.

The one or more controllable operable components may comprise components of the machine or implement. For example, the one or more controllers may be configured to controlling a forward speed of the machine, which may include modifying the speed and/or bringing the machine to a stop in dependence on an identification of an anomalous material flow.

Additionally or alternatively, the one or more controllers may be configured to control one or more components of the implement.

Where the implement comprises a header for a harvesting machine, this may include controlling an operational speed of rotational elements of the header, which may include a reel, augers or the like. This may include controlling an operational speed of conveyors or other components. This may include controlling a lift mechanism for the implement for controlling an operational position or height of the implement.

Where the implement comprises a boom having a plurality of outlets, the one or more controllers may be configured to control the flow of material to and/or through said outlets. Where the implement comprises a grass turning implement, the one or more controllers may be configured to control operation of one or more elements of the implement (e.g. one or more rotatable elements of the implement) to control the throwing distance and/or direction of material associated with the component.

Where the implement comprises a spreader tool, the one or more controllers may be configured to control one or more operable components of the spreader tool. For example, the spreader tool may include a steering mechanism, and the system may be operable to control one or more operating parameters of the steering mechanism to control the distribution of material from the spreader tool. For example, the steering mechanism may include one or more steering vanes or deflectors, and the system may be operable to control a position (e.g. a rotational position) of the steering vane(s) or deflector(s) to control a direction of deflection therefrom. The steering mechanism may include one or more rotors operable to provide a motive force for the material through the steering mechanism. For example, the rotor(s) may provide or induce an airflow through the steering mechanism, or may be operable to provide the motive force through contacting the material with one or more moveable elements of the rotor-e.g. a rotatable element. It will be appreciated that the speed at which the rotors operate may be used to control the extent to which the material is distributed from the spreader tool. Accordingly, the system may be operable to control a speed of the rotor(s) (e.g. a rotational speed of a rotatable element of the rotor(s). Where present, the first and/or second rotors may be provided in combination with fixed or moveable steering vane(s)/deflector(s). The one or more controllers may collectively comprise an input (e.g. an electronic input) for receiving one or more input signals. The one or more input signals may comprise sensor data from the event based sensor. The one or more controllers may collectively comprise one or more processors (e.g. electronic processors) operable to execute computer readable instructions for controlling operation of the control system, for example, to identify the material flow and/or to determine the one or more flow parameters. The one or more processors may be operable to generate one or more control signals for controlling operation of the one or more operational components. The one or more controllers may collectively comprise an output (e.g. an electronic output) for outputting the one or more control signals.

A further aspect of the invention provides an agricultural machine comprising the system of any aspect described herein. The agricultural machine may comprise a harvesting machine, such as a combine or forage harvester, for example.

A further aspect of the invention provides a method of monitoring operation of an implement for an agricultural machine, the method comprising: receiving sensor data from an event based sensor mounted or otherwise associated with the agricultural machine, the sensor data being indicative of an operating region of the implement; analysing the sensor data to identify a flow of material associated with the implement; determining one or more flow parameters for the material flow; and controlling operation of one or more operable components associated with the agricultural machine in dependence on the determined flow parameter(s).

The method may comprise performing any one or more of the functionalities of the control system described hereinabove.

A further aspect of the invention provides computer software comprising computer readable instructions which, when executed by one or more electronic processors, causes performance of a method in accordance with any aspect described herein.

A yet further aspect of the invention provides a computer readable medium having the computer software of the preceding aspect of the invention stored thereon.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 is a simplified side view illustrating a combine harvester embodying aspects of the present disclosure;

FIG. 2 is a simplified schematic view of a header embodying aspects of the present disclosure;

FIG. 3 is a schematic illustrating an embodiment of a system of the present disclosure;

FIG. 4 graphically illustrates sensor data obtained in performance of embodiments of the invention described herein; and

FIG. 5 is a schematic illustration of a tractor embodying aspects of the present disclosure.

### DETAILED DESCRIPTION

The figures illustrate embodiments of the present disclosure. Specifically, illustrated herein is illustrated a system 100 for monitoring operation of an implement, specifically a header 12 for an agricultural machine, specifically here a combine harvester 10. The system includes the use of an event based sensor 60; and a control system 101 which, as described herein, is configured to: receive sensor data from the event based sensor 60 indicative of an operating region of the implement and use this sensor data for controlling operation of one or more operable components associated with the harvester 10, which may include components of the header 12, or other components associated with the harvester 10, e.g. a user interface 62.

### Harvester

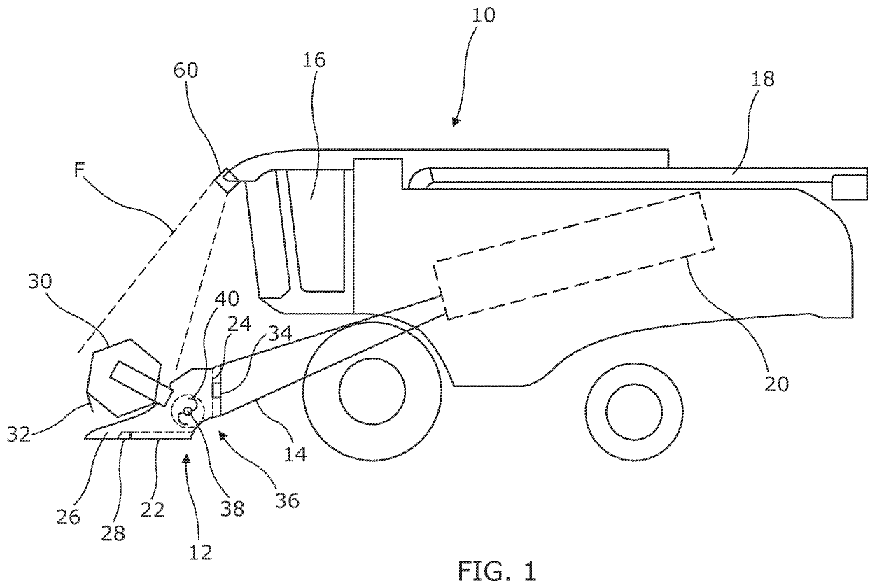

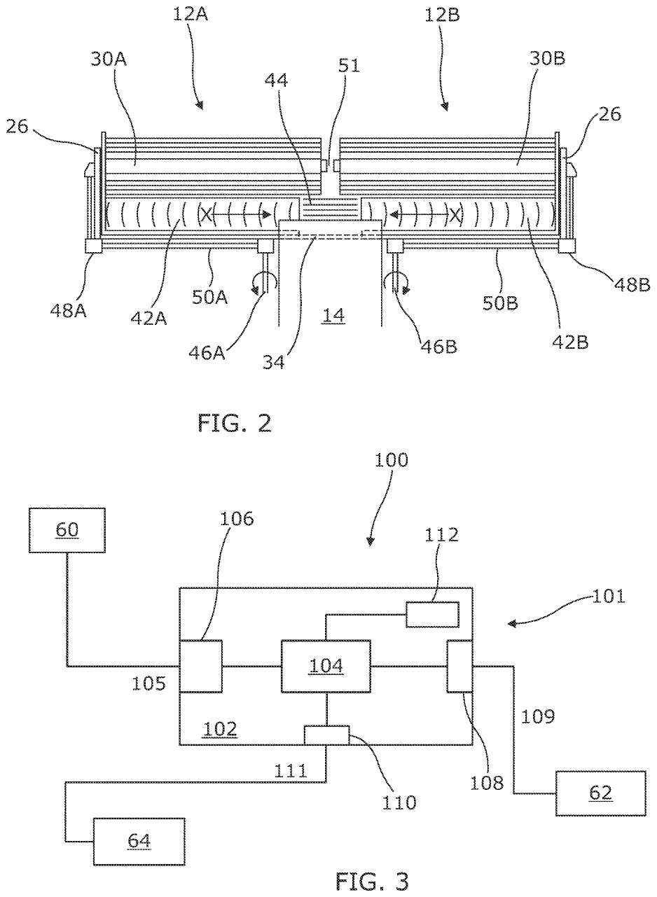

FIGS. 1 and 2 illustrate an agricultural machine in the form of a combine harvester 10 and implement in the form of a header 12 coupled to the harvester 10 illustrating aspects of the present invention.

The harvester 10 has the header 12 coupled in a known manner to a feederhouse 14 of the harvester 10. The harvester 10 also includes an operator cab 16, unloading auger 18 and a crop processing mechanism, indicated generally at 20, which is operable to separate grain and other crop material from the supporting crop matter. Various different configurations for the crop processing mechanism 20 are known, and will be apparent to the person skilled in the art so will not be described in detail herein. The invention is not limited in this sense.

The header 12 has a frame comprising a table (alternatively termed a bed or floor) 22, a rear wall 24 and two side walls 26. A standing crop such as cereals or maize is cut by a cutter bar 28 which is disposed on a leading edge of the table 22 as the harvester 10 advances in a forward direction across a crop field. A reel 30 is provided which guides the cut crop into the header 12. The reel 30 includes a plurality of guide bars 32, here six, which are mounted on (hexagonal) wheels which rotate around a transverse axis above the cutter bar 28. As particularly shown in FIG. 2, the illustrated header 12 comprises two crop gathering mechanisms or sub-assemblies (respectively identified by the suffixes A and B) 12A, 12B each having a respective reel 30A, 30B.

In FIG. 1, each sub-assembly 12A, 12B comprises an auger 36 which is suspended transversely across the width of the respective sub-assembly 12 in close proximity to the rear wall 24 and table 22. The auger 36 comprises a rotor core 38 supported for rotation by a support shaft (not shown). Screw-flighting 40 is secured to the rotor core 38. In operation, the auger 36A rotates and the flighting 40 engages the cut crop material so as to convey the crop material inwardly toward the centre of the header 12 e.g. in the direction of respective arrow X shown in FIG. 2.

FIG. 2 shows an alternative means for conveying the cut crop across the table 22 of the respective sub-assemblies 12A, 12B in the form of draper belts 42A, 42B which are driven conveyors extending across the respective portions of table 22 and which convey the cut crop inwardly in the direction of arrows X towards an opening 34.

In the illustrated embodiment in FIG. 2, the header 12 includes a further belt 44 in a central section between the sub-assemblies 12A, 12B. This further belt 44 operates transversely to the draper belts 42A, 42B (having received cut crop deposited by the draper belts) and carries the cut crop through the opening 34 and into the feederhouse 14 for onward handling by the crop processing mechanism 20.

In this embodiment, the crop gathering mechanisms (reels 30 and draper belt 42 or auger 36) of one header sub-assembly are operable independently of the (or each) other. As described in further detail herein, independent control of each sub-assembly 12A, 12B may be utilised in the present disclosure in dependence on material flow through the header 12, as determined through analysis of sensor data from the event based sensor 60.

In order to provide independent drive to the sub-assemblies, different options are possible and the invention is not limited in this sense. In the example shown in FIG. 2, mechanical drive is provided by separate (and independently driven) driveshafts 46A, 46B extending from the harvester 10, and via one or more universal joints 48A, 48B and intermediate driveshafts 50A, 50B, the rotation of the driveshafts is transferred to drive rotation of the respective reels 30A, 30B. As an alternative to mechanical drive, one or more of the crop gathering components may be provided with electric drive through one or more electric motors mounted on the header and driving the components directly. This arrangement is preferred where there are e.g. four or more sub-assemblies as the control connections become simpler than having multiple mechanical drive shafts, and the (generally shorter) header sections and sub-assemblies will require less power to drive.

The preceding description is provided for background, and illustrates how the header 12 may operate to provide a material flow into and through the header 12 through interaction with the components thereof.

### Event Based Sensor

As discussed herein, the present invention utilises an event based sensor 60 mounted on a foremost point of the operator's cab 16 and having a field of view which encompasses the header 12, and in particular an operating region of the header 12.

Event based sensor 60 has multiple individual sensing elements (pixels) which are individually triggerable in dependence on one or more variations in the signal output associated with those elements. The one or more variations result from a change in the light incident on said sensing elements, resulting in a change in amplitude in the output signal of those sensing elements. By setting relevant thresholds for said variations, “events” can be triggered in dependence on a given change in incident light on said sensing elements. The variations can be used as an indication of movement in the observed environment, for example, by monitoring successive triggers of adjacent sensing elements, and inferring movement in the observed scene based thereon. In further arrangements the overall sensor output for a given time period may be used—e.g. forming of a histogram or heat map of triggers-to obtain a measure of an overview of a given process—e.g. shape/size of flowpath material distribution, etc.

Operation of the event based sensor 60 may be controlled based on the given scenario. For instance a filter may be applied to the sensing elements to control at what magnitude of change/variation said sensing elements are triggered. This may be utilised to remove background events from the data. For instance, when using the sensor 60 on the harvester 10 during a harvesting operation, motion of the ground with respect to the harvester 10 may otherwise trigger the sensing elements. Accordingly, a filter can be applied based on the ground speed of the harvester 10 to reduce or eliminate false triggers thereof. Where the sensor 60 is used to monitor operation of components of the harvester 10, such as the header 12, or a material flow associated therewith, the operational speed of the implement/header 12 may be used to determine the filter to be applied to the sensor data to remove cyclical or repetitive motion from the scene—e.g. in order to identify anomalies or changes in that motion indicative of an operational issue.

In yet further use cases, a clustering process may be applied to the sensor data. This clustering may be a timewise and/or location based clustering to identify triggers at multiple sensing elements which correlate to the same physical observation. For instance, data may be clustered timewise to identify (and optionally track movement of) individual material components (e.g. pieces of straw or other crop material) in the sensor data. Clustering may be applied in dependence on a determined flow velocity of material (e.g. as determined through application of an optical flow measurement of the sensor data) which may be used to indicate regions within the field of view of the sensor where material may be travelling at different speeds to other regions or compared with an expected flow parameter. Regions within the sensing area where no triggers are seen (in areas where they would be expected—e.g. corresponding to a region of the header 12) may be indicative of a plugging of material or other fault preventing material flow in that region.

In the illustrated examples, and as described herein, the sensor data from event based sensor 60 is utilised to obtain a measure of a flow parameter(s) associated with material flow through the header 12.

### System

FIG. 3 illustrates an embodiment of a system 100 of the present disclosure. As discussed herein, the system 100 comprises a control system 101 operably connected to event based sensor 60. The control system 101 is configured for controlling one or more operational components 62, 64 associated with the harvester 10. In the illustrated embodiment, the controllable operational components include a local control unit 64 for controlling operation of the header 12 and one or more operable components thereof—e.g. reels 30, in dependence on flow parameters, determined in the manner discussed herein, and a user interface 62 associated with the combine harvester 10, here provided as a display terminal 62 in the operator cab 16 of the harvester 10 to provide a representation of the determined flow parameter(s).

Control system 101 comprises a controller 102 having an electronic processor 104, an electronic input 106 and electronic outputs 108, 110. The processor 104 is operable to access a memory 112 of the controller 102 and execute instructions stored therein to perform the steps and functionality of the present disclosure discussed herein, e.g. by controlling the user interface 62 to provide a representation of one or more flow parameters determined from sensor data from the event based sensor 60, and/or controlling operation of operable components of the header 12.

The processor 104 is operable to receive sensor data from event based sensor 60 via input 106 which, in the illustrated embodiment, takes the form of input signals 105. The sensor data is indicative of an operating region of the header 12. As discussed herein, the event based sensor 60 is mounted or otherwise coupled to the harvester 50 and obtain said sensor data as the harvester 50 moves through the environment.

The processor 104 is configured to analyse the sensor data and identify therefrom a flow of material associated with the header 12. One or more flow parameters, e.g. a measure of the uniformity of material flow across the header 12, a speed, direction of velocity distribution, etc. are determined for monitoring operation of the header 12 and the material flowing therethrough.

Controller 102 includes an electronic output 110 configured to output control signals 111 generated by the processor 104 for controlling operation of the header 12. Specifically, processor 104 is operable to generate, and the controller 102 operable to then output via output 108, control signals 109 to a local control unit 64 of the header 12 for controlling operable components thereof. As discussed herein, this may include controlling an operational speed of the components, e.g. of one or more reels 30, augers 38, draper belts 42, etc. in dependence on the flow parameters. This may include increasing or reducing the speed of the component(s). This may include bringing the component(s) to a stop to prevent damage—e.g. where the flow parameter(s) are indicative of a blockage in a particular region of the header 12, or component fault. This may be inferred where one region of the material flow is determined to be moving at a different speed to other areas of the header 12.

Output 108 is operably coupled to the user interface 62 in the form of a display terminal in the operator cab 16. As will be appreciated and is discussed herein, in alternative arrangement the user interface 62 may form part of a portable device, such as a phone or tablet computer. Here, the control system 101 is operable to control operation of the user interface 62, e.g. through output of control signals 109 in order to display data to an operator of the harvester 10 relating to the operation of the control system 101. Specifically, the control system 101 is operable to control the user interface 62 to display to the operator a representation of sensor data from the event based sensor 60, the identified material flow and/or a representation of the determined one or more flow parameters.

### Sensor Data

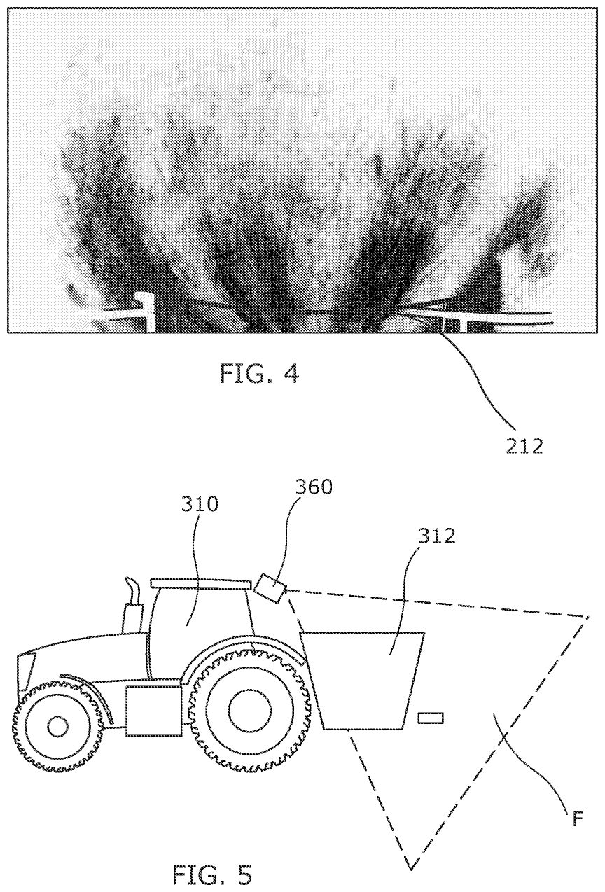

FIG. 4 illustrates sensor data obtained from an event based sensor mounted on the rear of an agricultural machine, specifically a combine harvester with a field of view which encompasses an implement in the form of a spreader tool 212 for spreading residue material behind the combine.

Here, the sensor data is represented in the form of a heatmap of events over a given time period corresponding to the change in light sensed at individual sensing elements due to movement of residue material within the sensing region. In forming the histogram of events a clear representation of the distribution of material flow from the spreader tool 212 is identified.

Further, in this example, the setup includes application of a filter to output signals from the sensing elements, specifically here dependent on a ground speed of the combine. Advantageously, the relative movement of the ground with respect to the machine, and hence the sensor is excluded from the sensor data, resulting in the sensing elements being triggered by movement of the residue material only, and the resultant heatmap illustrating the residue distribution, only.

One or more flow parameters for the material flow can be determined, for example, in the manner discussed herein. For example, a width of the distribution can be identified utilising an edge detection method for identifying a boundary between triggered and non-triggered sensing elements or regions in the formed histogram. A measure of the uniformity of the material distribution can be identified by looking at the intensity of events across the distribution. In the illustrated example, four separate regions of high event intensity is represented, corresponding to the spreader tool 212 outlets. In further examples, the characteristics can include a measure of a distance material is ejected in a given direction compared with an opposite direction-e.g. first and second directions/left-right of the machine, a shape or skew of the distribution, a maximum lateral extent of material spread by the spreader tool, or a density of material across the material distribution, for example.

Further, the one or more flow parameters can be used to determine a performance metric for the implement and its operation. This can include identifying an operational issue associated with the spreader tool 212, e.g. plugging of material, component breakage etc. Here, this is identified via a change in the flow parameter at the location of the blockage and/or at the location of faulty componentry of the spreader tool 212, and/or a difference in flow parameter(s) across the tool 212 and/or with respect to a baseline measurement. With the heatmap illustrated in FIG. 4, this may be represented by a reduction in trigger intensity at one or more locations or regions of the heatmap over time as less material is moving in that location.

In an extension of this, the flow parameter(s) may be calculated through performance of an optical flow measurement on the received sensor data. Turning back to the heatmap of FIG. 4, this can include performance of an optical flow measurement to determine a velocity and/or directionality of material flow over time by looking, for example, for patterns or instances of consecutive triggering of adjacent sensing elements as the heatmap is formed over time. Anomalies in the optical flow measurement may be indicative of unusual flow parameters and hence an issue with material flow and/or implement operation. For instance, an abrupt change in flow parameter in a given region of the sensor data and/or when compared with other areas of the sensor data may be indicative of a fault or component issues.

### Alternative Embodiments

FIG. 5 illustrates an alternative arrangement where system 100 is incorporated onto a tractor 310 having an implement, here in the form of a fertiliser spreader tool 312, operably coupled thereto. Event based sensor 360 is mounted on the rear of the tractor cab and has a field of view F which encompasses the spreader tool 312 and the surrounding region in to which fertiliser material is spread from the tool 312. As discussed herein, system 100 may be configured in a manner to determine one or more characteristics of the material distribution from the spreader tool 312, including a shape, uniformity or size of the material distribution, for example.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

What is claimed is:

1. A system for monitoring operation of an implement for an agricultural machine, the system comprising:
an event based sensor; and
a control system comprising one or more controllers, collectively configured to:
receive sensor data from the event based sensor indicative of an operating region of the implement;
analyse the sensor data to identify a flow of material associated with the implement;
determine one or more flow parameters for the material flow; and
generate and output one or more control signals for controlling operation of one or more operable components associated with the agricultural machine in dependence on the determined flow parameter(s).

2. A system of claim 1, wherein the one or more controllers are configured to utilise the determined flow parameter(s) to determine a performance metric for the implement and/or its operation.

3. A system of claim 2, wherein the one or more flow parameters are useable to identify an operational issue associated with the implement.

4. A system of claim 3, wherein the one or more controllers are configured to identify an operational issue in dependence on an identification of a change in a flow parameter; and/or a difference in flow parameter(s) across the implement and/or with respect to a baseline measurement.

5. A system of claim 2, wherein the performance metric comprises a measure of a uniformity of material flow across and/or from the implement.

6. A system of claim 1, wherein the one or more controllers are configured to control application of a filter to output signals from individual sensing elements of the event based sensor to remove triggers thereof due to background motion.

7. A system of claim 6, wherein the filter comprises a threshold for an output signal associated with the sensing elements.

8. A system of claim 6, wherein the filter is dependent on any one or more of:
a ground speed of the agricultural machine; and
an operational speed of the implement.

9. A system of claim 1, wherein the one or more controllers are configured to determine the flow parameter(s) through performance of an optical flow measurement on the received sensor data.

10. A system of claim 9, wherein the one or more controllers are operable to identify one or more anomalies in the optical flow measurement.

11. A system of claim 1, wherein the implement comprises one or more of: a header for a harvesting machine; a boom having one or more outlets for dispensing material therefrom; a spreader tool; and a grass turning implement.

12. A system of claim 1, wherein the one or more operable components of or otherwise associated with the machine include a user interface.

13. A system of claim 12, wherein the one or more controllers are configured to control output of an indicator indicative of the determined flow parameter(s), the one or more controllers being configured to generate and output a control signal(s) to the user interface for causing output of the indicator via the user interface to an operator of the machine.

14. A system of claim 13, wherein the indicator comprises an audible and/or visual warning indicative of an identified anomaly in the material flow associated with the implement.

15. A system of claim 14, wherein the indicator comprises a representation of the implement and/or the material flow associated therewith.

16. A system of claim 15, wherein the representation comprises a graphical representation of the implement and/or material flow via the user interface, the graphical representation comprising senor data and/or a generated virtual representation of the implement and/or material flow.

17. A system of claim 1, wherein the one or more controllable operable components comprise components of the machine or implement.

18. A system of claim 17, wherein the one or more controllers are configured to control one or more of:
a forward speed of the machine; and
an operational speed of one or more components of the implement.

19. An agricultural machine comprising the system of claim 1.

20. A method of monitoring operation of an implement for an agricultural machine, the method comprising:
receiving sensor data from an event based sensor mounted or otherwise associated with the agricultural machine, the sensor data being indicative of an operating region of the implement;
analysing the sensor data to identify a flow of material associated with the implement;
determining one or more flow parameters for the material flow; and
controlling operation of one or more operable components associated with the agricultural machine in dependence on the determined flow parameter(s).
